(19) United States
(12) Patent Application Publication
(10) Pub. No.: US 2004/0246106 A1
(43) Pub. Date: Dec. 9, 2004

(54) Electronically assisted memory aid

(76) Inventor: Olga Kain, Winston Hills (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/482,591

(22) PCT Filed: Jun. 21, 2002
(86) PCT No.: PCT/AU02/00817

(30) Foreign Application Priority Data
Jun. 21, 2001 (AU) PR 5848

(51) Int. Cl. G08B 1/00

(52) U.S. Cl. 340/309.16

(57) ABSTRACT

A memory aid device comprising an enclosure, wherein a front panel of said enclosure includes a plurality of portions adapted to accept handwritten erasable indicia; said front panel further including indicator lights wherein respective individual ones of said lights are associated with respective individual ones of said portions.

The present invention relates to devices for the notation of reminder messages and more particularly to devices allowing of recording erasable messages associated with a time keeping and alarm facility.

### BACKGROUND

The multiplicity of tasks facing most people as a concomitant of a busy daily life frequently raises the need for a reminder system. A commonly used system in both professional and domestic situations is a whiteboard which may serve as a temporary recording media for alerting oneself, members of the family or staff to required tasks.

A disadvantage of a simple whiteboard is that its messages are easily overlooked and the deadlines for such activities often missed. This is particularly true of elderly people suffering from dementia or other memory impairing conditions.

It is an object of the present invention to address or ameliorate at least one of the above disadvantages.

### BRIEF DESCRIPTION OF INVENTION

Accordingly, in one broad form of the invention there is provided a memory aid device comprising an enclosure, wherein a front panel of said enclosure includes a plurality of portions adapted to accept handwritten erasable indicia; said front panel further including indicator lights wherein respective individual ones of said lights are associated with respective individual ones of said portions.

Preferably said device is provided with electronic date and time keeping means;

Preferably said device is provided with microprocessor means and digital data storage means;

Preferably said device is provided with a digital display means mounted in said front panel;

Preferably said device is provided with an audio tone generating means adapted to emit an audible alarm;

Preferably said device is provided with a battery compartment for the stowage of primary batteries adapted to provide a power source for said device;

Preferably said device is provided with function keys, aid function keys mounted in said front panel;

Preferably said function keys are adapted for the entry of data for display on said digital data display means and for the storage of data in said digital data storage means;

Preferably said function keys are adapted for the retrieval of data from said digital data storage means, said retrieved data caused to be displayed on said digital data display means;

Preferably said function keys are adapted for the retrieval of date and time data from said date and time keeping means, said retrieved data caused to be displayed on said digital data display means;

Preferably an alarm condition is established for any one of said data fields by the association within said digital data storage means of the indicator light for that data field with a date and time set on said digital data display means;

Preferably said digital data storage means includes at least date, time and alarm condition storage means associated with each one of said horizontally arranged data fields;

Preferably said digital data display means is adapted to show selectably;

a. the current time,

b. the current date,

c. a time set for association with any one of said indicator lights,

d. a date set for association with any one of said indicator lights,

e. the current status of an alarm condition established for any one of said data fields,

f. the current state of power reserve in said primary batteries.

Preferably said digital data display means displays the current time as the default display;

Preferably said alarm condition associated with a said data field may be flagged as a single alarm so as to be activated once only;

Preferably said alarm condition associated with a said data field may be flagged as a cyclical alarm so as to be activated cyclically, said cycles selectably including daily, weekly and monthly cycles.

Preferably said indicator lights are in the form of push-button switches;

Preferably said indicator lights are light emitting diodes;

Preferably any one of said light emitting diodes of said indicator lights emits a flashing signal when a date and time associated with the data field of that indicator light coincides with said current date and said current time;

Preferably said audible alarm is activated when a date and time stored for association with any one of said data fields coincides with said current date and said current time;

Preferably the depressing of a flashing push-button switch causes the flashing of the light emitting diode of said switch and the audible alarm to be switched off; Preferably the depressing of a flashing push-button switch flags said alarm condition of said associated data field as “acknowledged” in said digital data storage means;

Preferably said flashing signal and said audible alarm will recur after the elapse of a cycle if said alarm is flagged as a cyclical alarm;

Preferably said function keys are adapted to retrieve the current alarm condition of any one of said data fields from said digital data storage means for display on said digital display means;

Preferably said function keys are adapted to retrieve said date and time set for association with any one of said data fields from said digital data storage means for display on said digital display means;

Preferably said handwritten erasable indicia are applied with a felt-tipped marker pen;

Preferably said handwritten erasable indicia are applied with a pencil;

Preferably said battery compartment is provided with additional space for the housing of a back-up battery, said back-up battery providing power to maintain the functions of said date and time keeping means and data stored in said digital data storage means during replacement of said primary batteries;

Preferably said enclosure is provided with magnetic support means disposed on the rear panel of said enclosure, said-magnetic support means adapted to attach the enclosure to a steel surface;

Preferably said rear panel of said enclosure is provided with holes disposed towards the two upper corners of said rear panel, said holes adapted to engage with suitable mounting fixtures on a substantially vertical surface;

Preferably said enclosure is provided with a retractable panel adapted for the recording of specific-use data;

Preferably said enclosure is provided with a receptacle in the form of a trough attached to the bottom of said front panel, said receptacle adapted to carry a marker pen or pencil.

### BRIEF DESCRIPTION OF THE DRAWINGS

Embodiments of the present invention will now be described with reference to the accompanying drawings wherein:

FIG. 1 is a front perspective view of a memory aid device according to a preferred embodiment of the present invention;

FIG. 2 is a rear perspective device to the memory aid of FIG. 1.

FIG. 3 is a schematic diagram of an electrical circuit of a preferred embodiment of the invention.

### DETAILED DESCRIPTION OF PREFERRED EMBODIMENTS

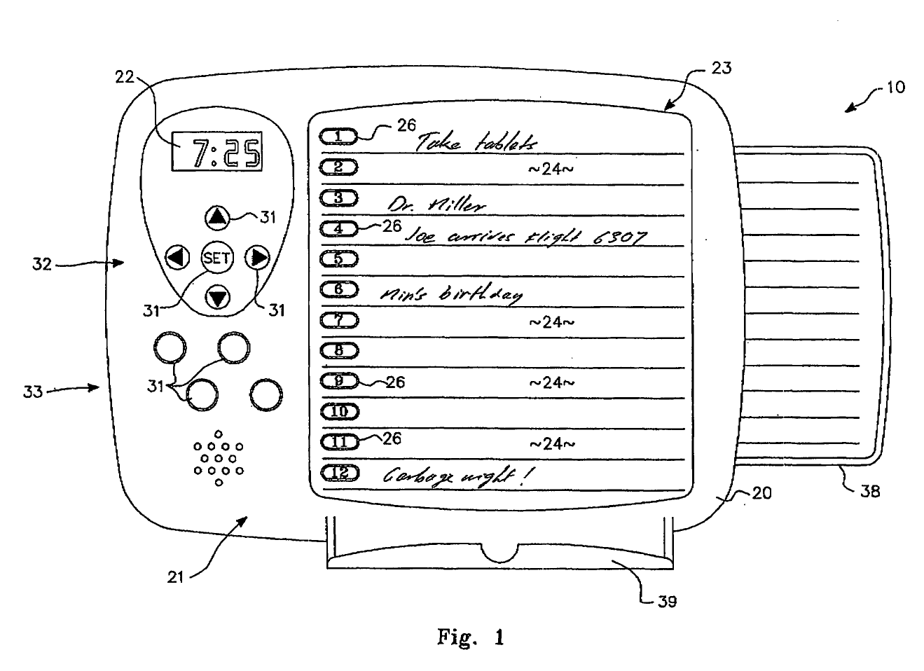

A preferred embodiment of the present invention will now be described with reference to FIG. 1 wherein a memory aid device 10 comprises a generally flat box-shaped enclosure 20 having a front panel 21.

Front panel 21 is provided with digital display means 22 preferably disposed in the top left hand corner of front panel 21.

Front panel 21 is further provided with a generally flat portion 23 defining a plurality of horizontally arranged data fields 24 adapted to accept handwritten erasable indicia 25 by means for example, of a marker pen such as commonly used for whiteboards and the like.

Each of data fields 24 is provided with an indicator light 26 preferably identified by number such that the topmost indicator light is accorded the number ‘1’ with the remaining lights numbered sequentially from the top to the bottom.

Preferably indicator lights 26 are in the form of a push-button switch incorporating a light emitting diode (LED).

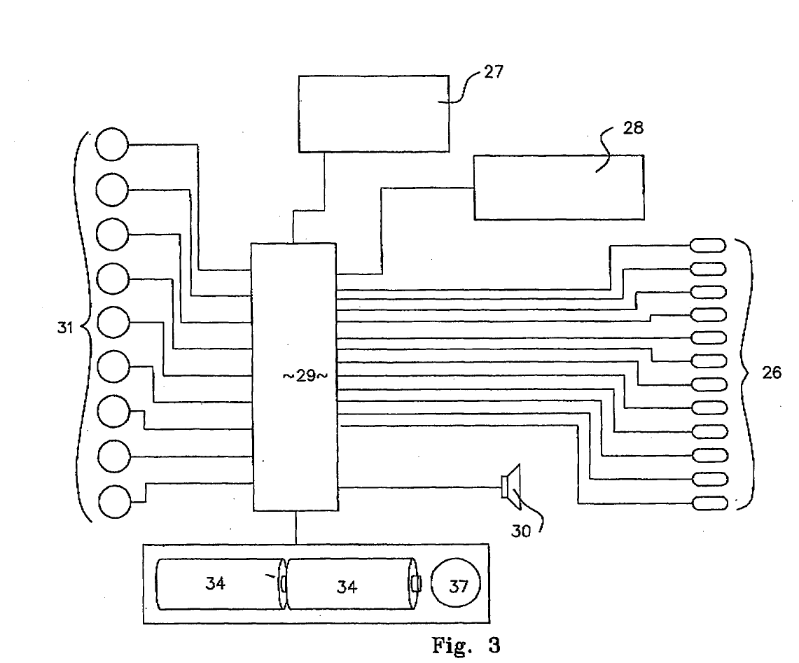

As indicated in FIG. 3 memory aid device is provided with means for electronic date and time keeping 27, digital data storage 28, microprocessor 29 and audio tone generator 30.

In this embodiment of the invention, digital display means 22 comprises a Liquid Crystal Display (LCD) module adapted to selectably display a range of data including at least:

a) the current time in hours and minutes preferably in the format HH:MM with an additional indicator for AM and PM,

b) the current date in day, month and year preferably in the format DD.MM.YY,

c) the date and time, if any assigned to a particular data field,

d) the status of any alarm condition currently associated with any of the data fields,

e) power reserves of primary batteries.

f) the identifying number of a selected data field

In this preferred embodiment digital display means 22 is adapted to accept the entry of a sequence of digits defining the password of a user of the device so that no new data may be entered or stored data modified unless preceded by the entry of a previously stored password.

Front panel 21 is further provided with a number of function keys 31 preferably arranged in two groups 32 and 33 below digital data display means 22. Preferably first group of function keys 32 are adapted to select and increment or decrement the value of indicia displayed on the LCD.

Preferably second group of function keys 33 are adapted to select from a number of available display and operational options.

In this preferred embodiment function keys 31 are push-button switches each incorporating an LED.

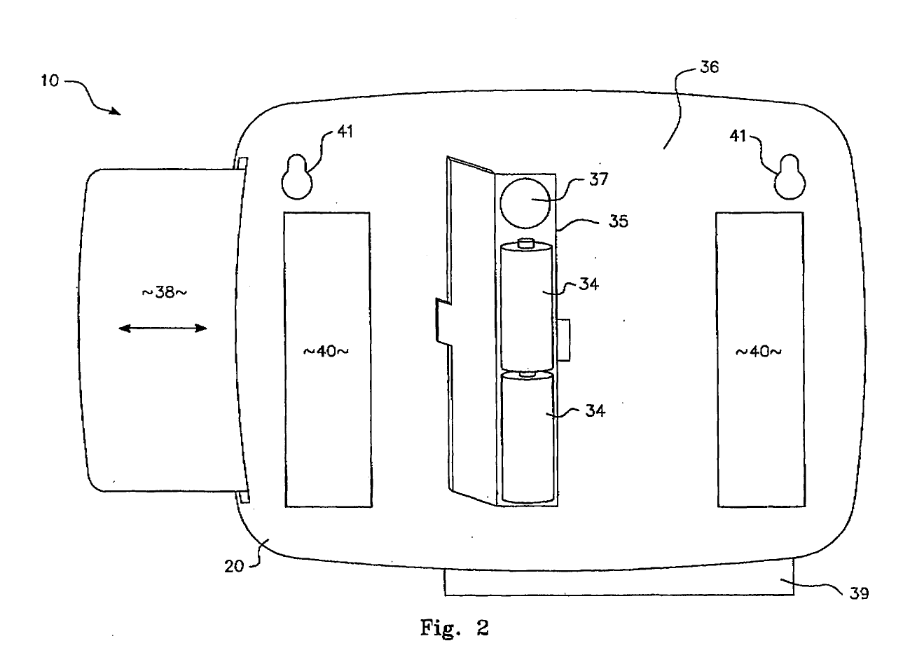

As illustrated in FIG. 2 memory aid device 10 is powered by primary batteries 34 stowed in battery compartment 35 preferably accessed from rear panel 36. Battery compartment 35 is further provided with a back-up battery 37 to provide power to the device when it is required to replace exhausted primary batteries.

Preferably enclosure 20 of the device is provided with a retractable panel 38 as shown in FIG. 2 which may be used for recording specific information relevant to the use or user of the device. Thus for example in a situation where the device is used to monitor the care of a patient, patient specific data such as medicinal and dosage information may be inscribed on the panel.

Preferably as shown in FIG. 1 the device is provided with a receptacle in the form of a trough 37 along the lower edge of the front panel 21 for the storage of a marker pen or pencil.

In a further preferred embodiment of the invention rear panel 36 is provided with magnetic support means 40 adapted to the weight of the device so as to allow its attachment to a substantially vertical steel surface.

Rear panel 36 is provided with holes 41 to allow suspension of the device from suitable support fixtures such as hooks or screws and the like affixed to a vertical surface.

In use, the primary function of memory aid device 10 is the facility to establish an association between a data field 24 and thus any indicia inscribed thereon, and a selected date and time so as to create an alarm condition for that data field. Thus a data field may be selected by depressing its indicator light push-button switch 26 and entering a date and time defining a future instant by means of digital display means 22 for storage in digital data storage means 28.

An alarm condition thus established may be further defined as a single alarm or a cyclical alarm. If a cyclical alarm, the cycle may be specified as daily, weekly or monthly.

When the date and time selected and stored for a particular data field coincides with the current date and time as generated by the date and time keeping means, the indicator light LED of the data field is caused to flash and an audible alarm tone generated by the audio tone generator, thus drawing attention to the indicia recorded on the data field.

The flashing of the indicator light LED and the sounding of the alarm tone will continue for a predetermined period unless the alarm is acknowledged prior to the expiry of that period. An alarm is acknowledged by the depressing of the indicator light pres-button switch.

Preferably, if the alarm is not acknowledged within the predetermined period, the flashing light and alarm tone will resume after an interval of time for a second predetermined period. Failure to acknowledge an alarm during either the first or second alarm periods will cause the alarm condition of the data field to be stored in the digital data storage means as an unacknowledged alarm. The status of any data field alarm condition may be interrogated by retrieving the stored status of an alarm condition from the digital data storage means and displaying it on the digital display means.

If the indicia previously inscribed on a data field are no longer required, they may be erased leaving the field available for a fresh notation and allowing the data entry of a new date and time.

A particular preferred embodiment of the present invention will now be described by way of example, however modifications, obvious to those skilled in the art, can be made thereto without departing from the scope and spirit of the present invention.

### EXAMPLE

### Technical Specification

By way of example, and with reference to the description of the first preferred embodiment, the following is a technical specification suitable for specifying the functional features of the device. In this section the memory aid 10 is referred to as a “task minder”.

### Functional Specification

1 Introduction

This document constitutes the functional specification for the Taskminder product/device. In particular this document describes the device keys and their function as well as the devices modes of operation and special functional features.

2 Definitions

A number of terms are used extensively throughout this document and are defined as follows:

System time: the time on the Taskminder clock. The user initially sets this to the current time.

System date: the date on the Taskminder calendar. The user initially sets this to the current date.

Alarm: the generation of a loud tone and/or flashing lights intended to draw the attention of the user.

Alarm condition: The event whereby an alarm is triggered. This occurs when the system time & date equals an enabled alarm time and date.

Alarm time: the time at which an alarm X is scheduled.

Alarm X date: the date at which alarm X is scheduled. An alarm X may also be scheduled as ‘daily’ or ‘weekly’.

Alarm X-Status: this refers to the status of an alarm. The status may be either ‘enabled’ or ‘disabled’. If alarm X is ‘disabled’ it cannot trigger an alarm condition.

Parameter: this is any value that can be modified. It includes dates, times, statuses and settings.

Protection Status: This may be ‘locked’ or ‘unlocked’. A ‘locked’ system does not allow the modification of parameters without the entry of a valid password. An ‘unlocked’ system allows the parameters to be modified freely.

Normal Operation: The mode of operation where the system is not powered down and the LCD displays the system time.

Note: X above is an integer from 1 to 12.

3 General Product Description

The Taskminder is an electronic memory aid designed for the intellectually challenged or for those with dementia. A carer or other person will be able to use the product to draw a patients attention to particular messages/reminders at scheduled times.

### Functional Specification

Attention is to be drawn to particular messages/reminders via audible alarms and flashing lights.

The product shall have twelve independent alarms that can be easily programmed via a keypad and LCD display. The messages/reminders are to be written on a white board area that is partitioned into twelve sections. Each section will correspond to a particular date and time alarm and have an associated key that is flashed during an alarm condition. By pressing the flashing key a patient indicates awareness of the message/reminder and the alarm condition shall be cleared.

4 System Components

4.1 LCD

The Taskminder shall have an LCD that has 6 digits, with each digit consisting of 7-

segments. The digits shall be aligned horizontally. The digits are referred in this

document as digits 1 to 6 numbering from left to right. Digit 2 and 3 shall have a

decimal point between them. Digits four and five shall have a decimal point and a

colon between them. The LCID shall also have ‘AM’ and ‘PM’ indicator segments.

The LCD shall be used to display the date and time information as well as other device statuses.

The date will be displayed in the format DD.MM.YY.

The time is displayed in the format HH:MM with AM and PM indicators.

4.2 Function Keys

The Taskminder product shall have the function keys described in Table 4.1:

### Functional Specification

TABLE 4.1
General Key Functions:

| Key Name | Illuminated | Function |
|---|---|---|
| TASK X | Yes | There shall be 12 task keys. Each |
| | | key is referred to in this |
| | | document as TASK X with X being |
| | | an integer from 1 to 12. Each |
| | | task key shall be used |
| | | acknowledge/clear its respective |
| | | task alarm condition and to |
| | | select the current alarm time for |
| | | modification or viewing. |
| UP | No | This key will be used during |
| | | modifying of a time or date to |
| | | increment a digit. |
| DOWN | No | This key will be used during |
| | | modifying of a time or date to |
| | | decrement a digit. |
| RIGHT | No | This key will be used to select |
| | | the next digit to the right |
| | | during modifying. |
| LEFT | No | This key will be used to select |
| | | the previous digit to the left |
| | | during modifying. |
| SET | No | This key will be used to select a |
| | | parameter to be modified or to |
| | | accept changes to modified |
| | | parameters. |
| TIME/DATE | Yes | This key will be used to view the |
| | | system time or date. |
| SUMMARY | Yes | This key will be used to view a |
| | | summary of which alarms the user |
| | | has acknowledged by pressing the |
| | | relevant TASK X key during |
| | | respective alarm condition. |
| LOCK | Yes | This key will be used to view the |
| | | system protection status. |
| SYSTEM | Yes | This key will be used to display |
| | | system settings such as alarm |
| | | volume. |

The keys will be software ‘debounced’ to stop multiple key presses occurring when a single key press is intended by the user.

4.3 Speaker/Buzzer

The Taskminder shall have a built in transducer that can generate audio tones. The tones will be used to provide feedback to the user during key presses and to indicate an alarm condition.

4.4 Real Time Clock Calender

The Taskminder shall have a built (hardware based) clock/calendar that can track the current time and date.

4.5 Battery Backup

A back up battery will support the operation of the clock calendar and the retention of system parameters when the main battery is being replaced.

### Functional Specification

5 Functional Description

5.1 Power Down

To conserve power the Taskminder shall power down whenever there is no key activity for more than 30 seconds in the normal mode of operation. During power down all keys will be dimmed (LED's switched off), the LCD switched off (blank) and audio transducer muted.

The system shall exit power down whenever a key is pressed or when a valid alarm condition occurs.

Note: A detailed power budget will be conducted during the development phase to determine the feasibility of leaving the LCD on at all times.

5.2 System Time & Date Functions

5.2.1 Displaying the System Time & Date

Pressing the TIME/DATE key once shall cause the TIME/DATE key to illuminate and the LCD to display the current system time (hours and minutes only). When the time is displayed the colon that separates the hours and minutes shall flash once each second to indicate that the clock is running.

Pressing the TIME/DATE key again shall cause the LCD to display the current system date. Subsequent presses of the TIME/DATE key shall cause the LCD to toggle between displaying the system time and system date.

If no key is pressed for thirty seconds, the system shall enter power down mode and the LCD switched off.

5.2.2 Modifying the System Time & Date

On first power up of the Taskminder the time and date will not be set (the time will be initialised to 12:00 pm and the date to Jan. 1, 2000). To indicate this condition the time and date will flash whenever they are displayed. Once the system time and date is set by the user the system time and date shall not longer flash when they are displayed.

To modify the system time the user will be required to first hold down the SET key for five seconds while the system time is displayed (see the previous section for details on displaying the system time & date). Following this a digit of the system time will begin to flash to indicate that it can be modified using the arrow keys (see section ‘Modifying Parameters’ for more details).

Similarly to modify the system date the user will be required to hold down the SET key for five seconds while the system date is displayed. After this the system date will begin to flash indicating that it can be modified using the arrow keys.

Once the system date or time is modified the set key will be pressed to accept the changes and return to normal operation (typically the system time is displayed).

### Functional Specification

Note: In order to modify the current system time or date the user will be required to first have either disabled password protection or entered a valid password. If password protection is enabled and a valid password is not entered the system will default to displaying the password protection status when the SET key is pressed (see the section ‘Password Protection Functions’ for more details).

5.2.3 Weekly and Daily Alarms

The Taskminder also supports daily and weakly alarms. To set an alarm date as daily the user will simply presses the TIME/DATE key when modifying the date (after SET has been held down for five seconds). The LCD will display the code word “dAILY”.

Pressing the TIME/DATE key again will cause the LCD to display the keyword “dAY X” where X represents the day of the week from (Monday to Sunday) with the numbers from 1 to 7 respectively. This is the day at which the alarm will go off each week at the alarm X time. The arrow keys can then be used to increment and decrement X.

Pressing the TIME/DATE key again will cause the alarm X date to be displayed. Pressing the SET key will return the system to normal operation and accept the date, weekly or daily alarm setting.

5.3 Alarm Functions

5.3.1 Alarms:

An alarm shall be triggered whenever the X alarm time and date is the same as the system time and date.

During the triggering of an alarm the Taskminder shall continuously flash the TASK X key (corresponding to the alarm X time that caused the alarm), display the system time and generate an audible alarm tone. Note: the audible alarm tone can be disabled by options in the system configuration (see section “System Options”).

It may also be possible to have independent audio disable feature for each alarm if desired, although this will require some additional development work

If the TASK X key is not pressed the alarm tone shall cease after 50 seconds and the TASK X key will continue to flash (the system will not power down). If the TASK X key is still not pressed the alarm tone will reoccur after 10 minutes for a further 50 seconds after which the system will return to normal operation.

If the TASK X key is pressed during either the first or second alarm tone, the alarm tone will cease immediately, the TASK X key will be dimmed and the alarm will be considered to be “acknowledged”. If the TASK X keys is pressed in the period between the fist and second alarm tones, the TASK X key is immediately dimmed and the alarm considered “acknowledged”. An “acknowledged” alarm will not reoccur until its next scheduled alarm time.

### Functional Specification

Information on which alarms have not been acknowledged can be obtainable by pressing the SUMMARY key. (See section “Alarm Summary Function”)

It will also be possible to have more than one alarm occur at the same time. In this case the alarming TASK keys will flash simultaneously. Each alarm must be acknowledged independently by pressing its respective TASK key. Once a flashing task key is pressed it will be immediately dimmed. When all the flashing TASK keys have been pressed then alarm tone will cease.

5.3.2 Viewing an Alarm Date, Time & Status:

If an alarm condition is not present and the TASK X key is pressed, the Taskminder shall illuminate the TASK X key and display the corresponding alarm X time on the LCD. If the TASK X key is pressed again within ten seconds, the alarm X date shall be displayed.

Pressing the alarm X key again will cause the alarm status to be displayed. An alarm status determines whether the alarm is enabled or disabled. A disabled alarm X will not trigger an alarm condition even if the system time and date is the same the alarm X time and date. A disabled alarm will be indicated on the LCD by the key word “OFF” and an enabled alarm will be indicated by key word “On”.

Subsequent presses of the TASK X key (all within 10 seconds of each other) will cause the LCD to cycle between displaying the date, time and status of alarm X After 10 seconds with no key press the LCD will default to displaying the current time and the TASK X key will be dimmed (LED switched off).

If there is no key activity for 30 seconds the system will default to normal operation.

5.3.3 Modifying an Alarm Date, Time & Status

To modify the alarm X time, the user will be required to first hold down the SET key for five seconds while the alarm X time is displayed (see the previous section for details on displaying the alarm X time). Following this the alarm X time on the LCD will begin to flash to indicating that it can be modified using the arrow keys (see section ‘Modifying Parameters’ for more details).

Similarly, to modify the alarm X date, the user will be required to first hold down the SET key for five seconds while the alarm X date is displayed. Following this a digit of the alarm X time on the LCD will begin to flash to indicating that it can be modified using the arrow keys.

In the same way, the alarm X status can be modified by first holding down the SET key for five seconds while the alarm X date is displayed. Following this a digit of the alarm X time on the LCD will begin to flash to indicating that it can be modified using the arrow keys.

After modifying the alarm X time, date or status the user will be able to accept the changes and return the system to normal operation by pressing the set key.

### Functional Specification

Note: In order to modify the current alarm X time, date or status, the user will be required to first have either disable password protection or entered a valid password. If password protection is enabled and a valid password is not entered the system will default to displaying the password protection status (see the section ‘Password Protection Functions’ for more details).

5.4 Password Protection Functions

5.4.1 Password Protection:

In order to discourage tampering with system parameters the Taskminder will support a password protection feature. This feature when enabled will inhibit modification of all parameters. A system where parameters cannot be modified is called a ‘locked’ system.

Alternatively the password protection may be disabled either permanently or temporarily. A system where password protection is permanently disabled is called an ‘unlocked system’. A system where the password protection is disabled temporarily is called ‘temporarily unlocked’ system.

To change a system protection status from ‘unlocked’ to ‘locked’ a password must be entered. To change a system protection status from ‘locked’ to ‘unlocked’ the same password used to last ‘lock’ the system must be entered.

Similarly a password must be entered to change a system protection status to ‘temporarily locked’. A ‘temporarily unlocked’ system changes its protection status automatically to ‘locked’ after power down (without a password being entered).

The advantage of ‘temporarily unlocking’ a ‘locked’ system as opposed to ‘unlocking’ it, is that it will not be necessary to re-enter a password to ‘re-lock’ the system once parameters are modified (this happens automatically).

At power up the password protection feature will be disabled by default.

5.4.2 Displaying the Protection Status:

Pressing the LOCK key will cause the LOCK key to illuminate and the system protection status to be displayed on the LCD. If the system is ‘locked’ the key word ‘LOCd’ will be displayed on the LCD. If the system is ‘unlocked’ the keyword ‘unLOCd’ will be displayed. Alternatively if the system is ‘temporarily locked’ the keyword ‘AUTO’ will be displayed.

If there is no key activity for 30 seconds the system will default to normal operation.

5.4.3 Modifying the Protection Status:

To modify the system protection status the user will be required to hold down the SET key for five seconds while the system protection status is displayed. This will then cause the protection status keyword to flash. The keyword can then be modified by

### Functional Specification

using the UP and DOWN arrow keys. Once a selection is made is finalised by pressing the SET key.

If system is unlocked (prior to modifying) and the keyword ‘LOCd’ is selected, a password entry sequence will be initiated. Once a password is entered, the system protection status will change to ‘locked’.

If the system is locked when the keyword ‘unLOCd’ or ‘AUTO’ is selected, a password entry sequence will be initiated. Once a valid (i.e. the entered password matches the one last used to ‘lock’ the system) the system protection status will change to ‘unlocked’. If a valid password is not entered the system returns to normal operation and the system protection status remains “locked”.

For the password entry sequence the value ‘0000’ will be displayed at position 1 to 4 on the LCD with digit 1 flashing. The digits on the LCD may then be modified using the arrow keys (see section ‘Modifying Parameters’ for more details). Once the desired modifications are complete pressing the set key will accept the entered value as an entered password.

If at any time during the modification of the system protection status (including password entry) there is no key activity for more than 30 seconds, the modification process will be aborted, the system will return to normal operation, and the system protection status will be unchanged.

If an attempt is made to modify a parameter such as the system time when the system is ‘locked’ (by holding the set key) the LCD will display the current protection status and the modification attempt disallowed.

5.5 Alarm Summary Function

When the SUMMARY key is pressed the Taskminder displays a summary of all the unacknowledged alarms (this is called an alarm summary). An unacknowledged alarm occurs when an alarm is not cleared by pressing the corresponding TASK X key. This facility allows a carer to determine whether or not a patient is paying attention to the alarms.

If an alarm was not acknowledged, then the corresponding TASK X will illuminate and flash when the SUMMARY key is pressed. If an enabled alarm has not yet occurred it will illuminate but not flash. Acknowledged or disabled alarms will have their corresponding TASK X key dimmed.

After 30 seconds with no key activity the system will default to normal operation.

5.6 System options

5.6.1 Viewing the Alarm Volume

The volume of the alarm will be set to one of three levels (including off). The alarm volume setting will be displayed by pressing the SYSTEM key. By default the volume is set to high after first power up.

### Functional Specification

If the alarm tone is disabled the keyword ‘OFF’ will be displayed on the LCD when the SYSTEM key is pressed. If the volume is low the keyword ‘Lo’ will be displayed. If the volume is High the keyword ‘Hi’ will be displayed.

After 30 seconds with no key activity the system will default to normal operation.

5.6.2 Changing the Alarm Volume

To modify the alarm volume, the user will be required to first hold down the SET key for five seconds while the volume setting is displayed (see the previous section for details on displaying the alarm volume). Following this the alarm volume keyword on the LCD will begin to flash to indicating that it can be modified using the arrow keys (see section ‘Modifying Parameters’ for more details).

After modifying the alarm volume pressing the SET key will accept the changes and return the system to normal operation.

5.7 Modifying Parameters

5.7.1 Selecting a Parameter for Modification

To modify a parameter the user will hold down the SET key for five seconds while the parameter to be modified is being displayed. This will cause a the left most editable digit to flash. In the case of code words such as “unLOCd” the entire keyword flashes.

5.7.2 Incrementing, Decrementing or Changing a Parameter

By pressing the UP key, a flashing digit/code-word may be incremented/changed. Once a maximum value is reached the flashing digit changes to the minimum value with the next UP key press.

Pressing the DOWN key causes the value of the flashing digit to decrement/change.

Once the minimum value is reached the maximum value is displayed with the next DOWN key press.

Note: When entering dates the minimum and maximum value will depend on the legal dates according to the calendar.

5.7.3 Selecting the Digit to Modify

Pressing the right arrow key causes the next editable digit to the left to begin flashing (the other digits do not flash). If the right most digit is reached pressing the RIGHT key will then cause the left most digit to flash. Similarly pressing the LEFT key when the left most digit is reached causes the rightmost digit to flash.

In this way all the digits can be made to flash intern and can thus be modified using the UP and DOWN keys.

### Functional Specification

5.7.4 Accepting or Aborting Parameter Changer

During the modification of a parameter, pressing the SET key will cause the current modified value of the parameter to be excepted. If another key is pressed (for instance the TIME/DATE key) the modify procedure is aborted and the original value is retained. The system then executes the function appropriate to the key that was pressed.

5.8 Low Battery Condition

When a low battery is detected, the system displays the keyword “Lo Bat” for 5 seconds (prior to performing any other functions) every time it exits power-down.

When the battery is critical low the system will no longer exit power down mode until the battery is replaced.

What is claimed is:

1. A memory aid device comprising an enclosure, wherein a front panel of said enclosure includes a plurality of data fields adapted to accept handwritten erasable indicia; said front panel further including indicator lights wherein respective individual ones of said lights are associated with respective individual ones of said portions.

2. The memory aid device of claim 1 wherein, said device is provided with electronic date and time keeping means.

3. The memory aid device of claim 2 wherein, said device is provided with microprocessor means and digital data storage means.

4. The memory aid device of claim 3 wherein, said device is provided with a digital data display means mounted in said front panel.

5. The memory device of claim 1 wherein, said device is provided with an audio tone generating means adapted to emit an audible alarm.

6. The memory aid device of claim 1 wherein, said device is provided with a battery compartment for the stowage of primary batteries adapted to provide a power source for said device.

7. The memory aid device of claim 1 wherein, said device is provided with function keys, aid function keys mounted in said front panel.

8. The memory aid device of claim 7 wherein, said function keys are adapted for the entry of data for display on said digital data display means and for the storage of data in said digital data storage means.

9. The memory device of claim 7 wherein, said function keys are adapted for the retrieval of data from said digital data storage means, said retrieved data caused to be displayed on said digital data display means.

10. The memory device of claim 7 wherein, said function keys are adapted for the retrieval of date and time data from said date and time keeping means, said retrieved data caused to be displayed on said digital data display means.

11. The memory device of claim 4 wherein, an alarm condition is established for any one of said plurality of data fields by the association within said digital data storage means of the indicator light for said one of said plurality of data field with a date and time set on said digital data display means.

12. The memory aid device of claim 3 wherein, said digital data storage means includes at least date, time and alarm condition storage means associated with each one of said plurality of data fields.

13. The memory aid device of claim 4 wherein, said digital data display means is adapted to show selectably;
the current time,
the current date,
time set for association with any one of said indicator lights,
a date set for association with any one of said indicator lights,
the current status of an alarm condition established for any one of said data fields, and
the current state of power reserve in said primary batteries.

14. The memory aid device of claim 4 wherein, said digital data display means displays the current time as the default display.

15. The memory device of claim 12 wherein, said alarm condition associated with a said data field may be flagged as a single alarm so as to be activated once only.

16. The memory device of claim 11 wherein, a said alarm condition associated with a said data field may be flagged as a cyclical alarm so as to be activated cyclically, said cycles selectably including daily, weekly and monthly cycles.

17. The memory aid device of claim 1 wherein, said indicator lights are in the form of push-button switches.

18. The memory aid device of claim 1 wherein, said indicator lights are light-emitting diodes.

19. The memory aid device of claim 18 wherein, any one of said light emitting diodes of said indicator lights emits a flashing signal when a date and time associated with the data field of that indicator light coincides with said current date and said current time.

20. The memory aid device of claim 13 wherein, said audible alarm is activated when a date and time stored for association with any one of said data fields coincides with said current date and said current time.

21. The memory aid device of claim 18 wherein, the depressing of a flashing push-button switch causes the flashing of said light emitting diode of said switch and said audible alarm to be switched off.

22. The memory aid device of claim 11 wherein, the depressing of a flashing push-button switch flags said alarm condition of said data field associated with said flashing push-button switch as “acknowledged” in said digital data storage means.

23. The memory aid device of claim 19 wherein, said flashing signal and said audible alarm will recur after the elapse of a cycle if said alarm is flagged as a cyclical alarm.

24. The memory device of claim 7 wherein, said function keys are adapted to retrieve the current alarm condition of any one of said data fields from said digital data storage means for display on said digital data display means.

25. The memory aid device of claim 19 wherein, said function keys are adapted to retrieve said date and time set for association with any one of said data fields from said digital data storage means for display on said digital display means.

26. The memory aid device of claim 1 wherein, said handwritten erasable indicia are applied with a felt-tipped marker pen.

27. The memory aid device of claim 1 wherein, said handwritten erasable indicia are applied with a pencil.

28. The memory aid device of claim 6 wherein, said battery compartment is provided with additional space for the housing of a back-up battery, said back-up battery providing power to maintain the functions of said date and time keeping means and data stored in said digital data storage means during replacement of said primary batteries.

29. The memory aid device of claim 1 wherein, said enclosure is provided with magnetic support means disposed on the rear panel of said enclosure, said magnetic support means adapted to attach the enclosure to a steel surface.

30. The memory aid device of claim 29 wherein, said rear panel of said enclosure is provided with holes disposed towards the two upper corners of said rear panel, said holes adapted to engage with suitable mounting fixtures on a substantially vertical surface.

31. The memory aid device of claim 1 wherein, said enclosure is provided with a retractable panel adapted for the recording of specific-use data.

32. The memory aid device of claim 1 wherein, said enclosure is provided with a receptacle in the form of a trough attached to the bottom of said front panel, said receptacle adapted to carry a marker pen or pencil.
